(19) United States
(12) Patent Application Publication
(10) Pub. No.: US 2010/0057783 A1
(43) Pub. Date: Mar. 4, 2010

(54) On-line Documentation System

(75) Inventor: Ching-Min Huang, Tainan County (TW)

Correspondence Address: CHING-MIN HUANG, 3F, NO. 5, ALY. 47, LN. 76, ZHONGXIAO RD.,, YONGKANG CITY,, TAINAN COUNTY, 710, TW

(73) Assignee: Ching-Min Huang

(21) Appl. No.: 12/199,535

(22) Filed: Aug. 27, 2008

(51) Int. Cl. G06F 17/30

(52) U.S. Cl. 707/200; 707/E17.005

(57) ABSTRACT

The proposed new documentation system, On-line Documentation System, is according to the requirements of the document management.

### BRIEF SUMMARY

Through the use of Internet, this software allows users to create portable documents, via the on-line documentation system, that are easy to browse, file and manage.

### BACKGROUND

The format of a document can range from hardcopy, typewriter, computer, to portable format. However, for an organization, inconsistency in file format or layout can often create problems when filing or categorizing items. Online processing is an inevitable trend, and thus the importance of establishing templates should not be underestimated. This software can help to facilitate the filing and management of documents for governmental, educational, public, and private organizations.

### DETAILED DESCRIPTION

The structure of the on-line documentation system is as follows:

1. The functions of the on-line documentation system include:
On-line server;
Default or customized document templates.

2. On-line Server
Add, delete and modify the administrator's accounts, data, authorities;
Add, delete and modify the user's accounts, data, authorities;
The system includes: document server, document translator, database server, E-mail server and file server;
Interactive user interfaces.

3. File Templates
Default
   Standard templates created and saved by the developers of the on-line documentation system;
   Non-standard templates created and saved by the developers of the on-line documentation system;
Customize
   Group user
      Templates created and saved on the server-end for group use;
   Individual user
      Templates created and saved on individual computer for own use.

4. Document Functions
File
   Define the design, catalogue, chapter, paragraph;
   Define the paper size;
   Define the top, bottom, left and right margins;
   Define the font size;
   Define the font style;
   Define the row spacing;
   Define the paragraph interval;
   Define the paragraph indent;
   Define the line number;
   Define the page number;
   Define the field;
   Define the equation;
      Define the equation to simplify;
      Define the equation to complicate;
      Define the symbolic operation of the equation;
      Define the drawing of the equation;
   Define symbols;
   Define the page style;
   Define text direction (vertical or horizontal);
   Define the symbol of the bulleted list;
   Define the serial number of the bulleted list;
   Define the watermark;
   Define the color of the document;
   Define references and their quotations;
   Define the picture drawing of the vector format and its quotation;
   Define the picture editor and its quotation;
   Define the embedded picture and its quotation;
   Define the table and its quotation;
      Define the mathematical function for automatic calculation;
      Define the chart for automatic drawing;
   Define the paper preview;
   Define the embedded components;
   Define the embedded briefing;
   Storing the template.
Presentation
   Define the style, catalogue, chapter, paragraph;
   Define the font size;
   Define the font style;
   Define the row spacing;
   Define the paragraph interval;
   Define the paragraph indent;
   Define the line number;
   Define the page number;
   Define the equation;
      Define the equation to simplify;
      Define the equation to complicate;
      Define the symbolic operation of the equation;
      Define the drawing of the equation;
   Define symbols;
   Define the page style;
   Define text direction (vertical or horizontal);
   Define the symbol of the bulleted list;
   Define the serial number of the bulleted list;
   Define the watermark;
   Define the color of the document;
   Define references and their quotations;
   Define the picture drawing of the vector format and its quotation;
   Define the picture editor and its quotation;
   Define the embedded picture and its quotation;
   Define the table and its quotation;
      Define the mathematical function for automatic calculation;
      Define the chart for automatic drawing;
   Define the paper preview;
   Define the embedded components;
   Define the embedded document;
   Storing the template.
File Conversion
   Convert to portable file format;
   Convert to graphic file format;
   Save as word format;
   Save and create database link.
Database Functions
   Define the auto backup mechanism of databases when under different operating environment;
   Define the search key for documents on file;
   Use the database language to search document;
   Link the relative or specific address of the file.
E-mail Functions
   Define the auto backup mechanism of E-mails when under different operating environment;
   Add, delete and modification of e-mail data;
   Define the rules for auto sending;
   Auto-send e-mail.
File Functions
   Define the auto backup mechanism of documents when under different operating environment;
   Define daily sheet, report form, monthly report form, annual report form, irregular report form and the calculation mechanism;
   Define the verifying mechanism of the document;
   Define the user progress-tracking mechanism;
   View reports and documents online.

1. The inventor gets a 2% royalty.

2. The users endow a 6% royalty to medical, environmental, and charity organizations with anonymity; if contributors disclose themselves to the public, the subscription is invalid.
